(19) United States
(12) Patent Application Publication
(10) Pub. No.: US 2008/0307354 A1
(43) Pub. Date: Dec. 11, 2008

(54) Information processing apparatus

(75) Inventors: Satoshi Ejima, Setagaya-ku (JP); Akihiko Hamamura, Chiba-shi (JP)

Correspondence Address: OLIFF & BERRIDGE, PLC, P.O. BOX 320850, ALEXANDRIA, VA, 22320-4850, US

(73) Assignee: Nikon Corporation, Tokyo (JP)

(21) Appl. No.: 12/222,221

(22) Filed: Aug. 5, 2008

Related U.S. Application Data
(63) Continuation of application No. 11/234,208, filed on Sep. 26, 2005.
Application No. 11/234,208 is a continuation of application No. 08/965,197, filed on Nov. 6, 1997, now abandoned.
(60) Provisional application No. 60/033,586, filed on Dec. 20, 1996.

(30) Foreign Application Priority Data
Dec. 6, 1996 (JP) JP-08-326546
Apr. 15, 1997 (JP) JP-09-096907

(51) Int. Cl. G06F 3/048

(52) U.S. Cl. 715/803

(57) ABSTRACT

In order to efficiently display a plurality of images on a display screen, the display screen is divided into a number of areas based on the number of images that are designated for display. For example, if four information items are selected and designated for display, the screen is divided into four areas, each area displaying one of the selected information items. Image information is reduced in size for display in each divided area, and sound information can be represented by a corresponding symbol (e.g., a musical note). If five or more information items are selected and designated for display, then the screen is divided into nine areas, and each of the selected images is displayed in one of the divided areas.

### RELATED APPLICATION

This is a Continuation of application Ser. No. 08/965,197 filed Nov. 6, 1997. The entire disclosure of the prior application is hereby incorporated by reference herein in its entirety.

This non-provisional application claims the benefit of Provisional Application No. 60/033,586 filed Dec. 20, 1996.

### INCORPORATION BY REFERENCE

The disclosure of the following priority application is herein incorporated by reference: Japanese Patent Application No. 8-326546, filed Dec. 6, 1996.

### BACKGROUND OF THE INVENTION

1. Field of the Invention

This invention relates to an information processing apparatus, and more particularly, to an information processing apparatus that is capable of efficiently displaying a plurality of images on a screen by dividing the screen into a plurality of areas corresponding to the number of the images to be displayed.

2. Description of Related Art

Recently, electronic cameras using, for example, a CCD (Charge-Coupled-Device) have been used in place of cameras using film. In such electronic cameras, the image captured through the CCD is converted to digital data and recorded in a built-in memory or a detachable memory card. The image photographed by the electronic camera can be immediately reproduced and displayed on the screen of an LCD or CRT, without conducting development and printing, unlike a conventional film-type camera.

Some electronic cameras are capable of accepting audio data or hand-written memo input by users, and of displaying multiple images on the screen at the same time by dividing the screen into a plurality of areas. In addition, a technique for storing the audio data or hand-written memo in association with the image has been proposed. This allows users to record surrounding (related) sound during the photographing, or to record hand-written comments on the photographed place or objects. Furthermore, users can select a desired image from the multiple images simultaneously displayed on the screen and display the selected image on the entire area of the screen.

However, when displaying a plurality of images on the screen of a conventional electronic camera, the number of divided areas and the size of each area are fixed in advance. Thus, users cannot flexibly display multiple images on the screen.

For example, if a user wants to display four images on the screen using an electronic camera capable of dividing the screen into nine areas and displaying up to nine images, then the first four areas among the nine areas are used for displaying the images, and the rest of the areas do not bear any images. In such a case, it would be preferable to divide the screen into four areas.

Furthermore, there is another problem in an electronic camera capable of recording sound or memorandums other than images. Because users may want to display a plurality of images together with the associated information, such as hand-written memo, how and where to display such associated information on the divided screen must be determined in advance.

### SUMMARY OF THE INVENTION

This invention was conceived to overcome these problems, and aims to provide an information processing apparatus that is capable of displaying a plurality of images on a screen in an efficient manner.

To achieve the above and other objects, an information processing apparatus according to the invention divides a display screen into a plurality of display areas according to the number of designated images and then displays the designated images in their respective display areas. An image input means (e.g., a photoelectric converter such as a CCD) inputs images. A designation means (e.g., a touch tablet and pen) designates one or more images among the images input through the image input means. A display control means (e.g., a CPU) displays the one or more images designated by the designation means on predetermined areas of a screen. A dividing means (e.g., the CPU) divides the screen into a plurality of display areas according to the number of the images designated by the designation means. The display control means displays each of the images designated by the designation means on one of the display areas divided by the dividing means.

The display control means may display the designated images on the divided display areas as reduced images.

The dividing means may divide the screen so that the aspect ratio of the divided display areas becomes equal to the aspect ratio of the designated images.

The dividing means may divide the screen into n² areas (where n is a natural number) when the number of the designated images is greater than (n−1)² and equal to or less than n².

The designation means may prohibit a user from designating images exceeding a predetermined number.

The information processing apparatus may further comprise selection means (e.g., the touch tablet and pen) for selecting one of the images displayed on the divided display areas. When an image is selected, the display control means may display the selected image in the entire area of the screen.

The information processing apparatus may further include sound input means (e.g., a microphone) for inputting sound. The designation means may designate one or more images and any related sound input through the sound input means.

When images are designated by the designation means, and when the designated images have associated sound input through the sound input means, then the display control means may display the designated images in the display areas of the screen together with a symbol indicating that there is sound input associated with the images.

When sound is designated by the designation means, and when there is no image associated with the designated sound, then the display control means may display a symbol corresponding to the designated sound on the display area.

The information processing apparatus may further comprise sound playback means (e.g., the CPU) for playing back the sound. When the image selected by the selection means has corresponding sound, then the display control means may display the selected image in the entire area of the screen, while the sound playback means reproduces the corresponding sound.

If the number of the images designated by the designation means is greater than n², then the dividing means divides the screen into n² display areas, and the display control means displays n² images among the designated images in the divided display areas. The display control means may display the first n² images or the last n² images among the designated images on the divided display areas.

When the designation means designates images, the designated images are displayed on the screen in a reduced size. The size of the divided display area is larger than the size of the reduced image.

The information processing apparatus may further include line-drawing input means (e.g., a touch tablet and pen) for inputting line-drawings. When the images designated by the designation means have corresponding line-drawings input through the line-drawing input means, then the display control means may display the designated images and the corresponding line-drawings on the screen so that the line-drawings are superimposed on the corresponding images.

The information processing apparatus may further include display means (e.g., an LCD) for displaying the images.

According to another aspect of the invention, an information processing apparatus includes image input means (e.g., the CCD) for inputting images, designation means (e.g., the touch tablet and pen) for designating one or more images input through the image input means, and display control means (e.g., the CPU) for controlling the display size of images according to the number of the images designated by the designation means.

A recording medium can also be provided that stores a computer-readable control program to control the image processing apparatus. The control program includes instructions that cause the apparatus to receive a designation of one or a plurality of images, divide a display screen into a plurality of display areas corresponding to the number of designated images, and display the one or plurality of designated images in corresponding areas of the divided display screen.

### BRIEF DESCRIPTION OF THF DRAWINGS

The invention will be described in conjunction with the following drawings in which like reference numerals designate like elements and wherein:

FIG. 1 is a front, perspective view of an electronic camera to which the present invention is applied;

FIG. 2 is a rear, perspective view of the electronic camera showing the LCD cover in an open state;

FIG. 3 is a rear, perspective view of the electronic camera showing the LCD cover in a closed state;

FIG. 4 shows the internal structure of the electronic camera;

FIGS. 5A-5C are side views of the electronic camera and illustrate the use of an LCD switch and an LCD cover;

FIG. 6 is a block diagram showing the electric structure of the electronic camera;

FIG. 7 shows a first pixel thinning-out process;

FIG. 8 shows a second pixel thinning-out process;

FIG. 9 shows an example of an information list displayed on the LCD of the electronic camera;

FIG. 10 shows an example of the entire LCD screen displaying the information list;

FIG. 11 shows an example of image display in which the display screen is divided into four image areas;

FIG. 12 shows another example of image display in which the display screen is divided into four image areas;

FIG. 13 shows still another example of image display in which the display screen is divided into four image areas;

FIG. 14 shows image B, which was selected among the images of FIGS. 11-13, displayed on the entire screen;

FIG. 15 shows an example of image display when ten or more information items are selected for display;

FIG. 16 shows another example of image display when ten or more information items are selected for display;

FIG. 17 shown still another example of image display when ten or more information items are selected for display;

FIG. 18 shows a flow chart that explains one sequence for dividing the screen in accordance with the number of the selected information items; and

FIG. 19 shows an example of a case in which five information items are displayed on a screen divided into nine image areas.

### DETAILED DESCRIPTION OF PREFERRED EMBODIMENTS

The preferred embodiments of the invention will be described in more detail referring to the drawings.

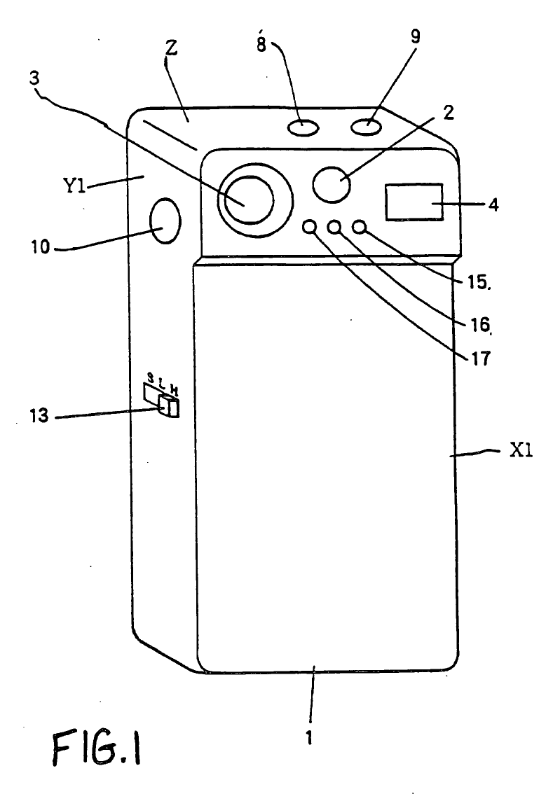

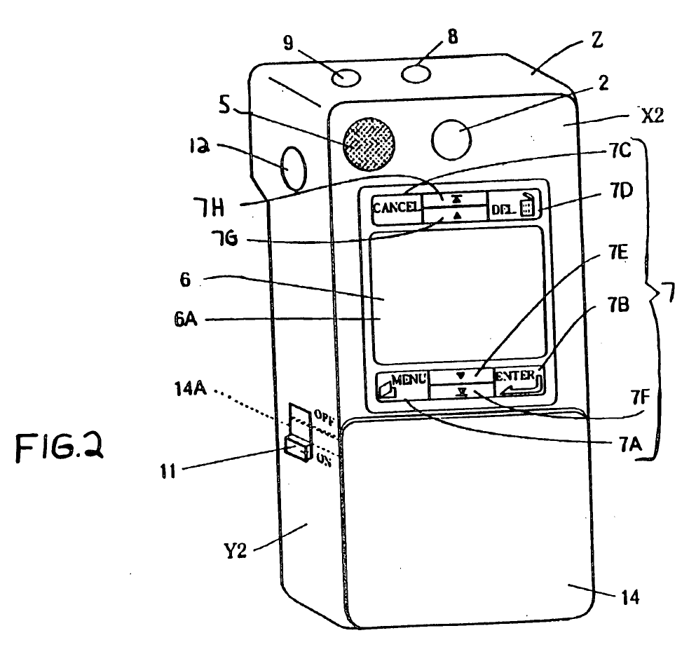

FIGS. 1 and 2 are perspective views of one example of an electronic camera 1 to which the present invention is applied. In this embodiment, the camera surface facing the object is referred to as “Face X1”, and the surface closer to the user is referred to as “Face X2”. A viewfinder 2 for confirmation of the photographing scope of the object, a photographic lens 3 for taking in the optical (light) image of the object, and a flash (strobe) lamp 4 for emitting light to illuminate the object are provided on the top of Face X1.

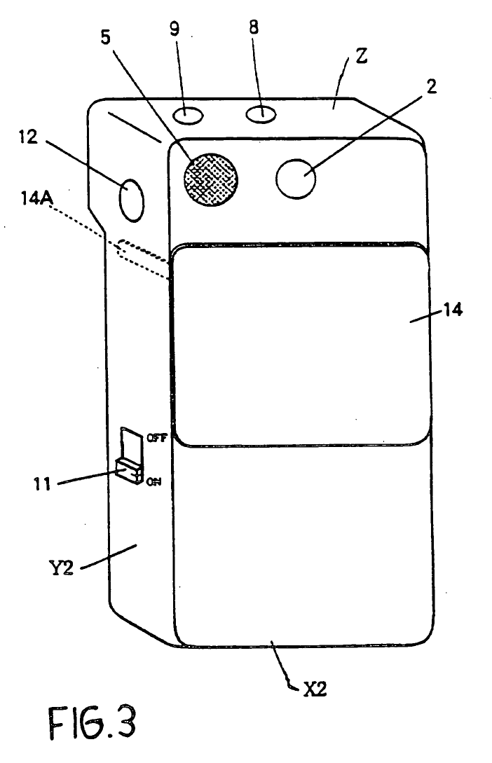

The Face X1 also includes a red-eye reduction (RER) LED 15 that is illuminated prior to flashing the strobe lamp 4 to reduce the red-eye phenomena, a photometry element 16 that performs photometry when the CCD 20 (FIG. 4) is not activated, and a color measuring (colorimetry) element 17 that measures the color level when the CCD 20 is not activated.

The Face X2, which is the opposite side of Face X1, is provided with a viewfinder 2 and a speaker 5 for outputting sound recorded in the electronic camera 1 at the top portion thereof (corresponding to the top of Face X1 in which the viewfinder 2, photographic lens 3 and flash lamp 4 are provided). LCD 6 and operation keys 7 formed in Face X2 are positioned below the top part in which the viewfinder 2, photographic lens 3, flash lamp 4 and speaker 5 are provided. A touch tablet 6A is provided on the surface of the LCD 6 so that position data is output corresponding to the position designated through contact of a pen-type designator (with the touch tablet 6A), which will be described below.

The touch tablet 6A is made of transparent material, such as glass or resin, so that the user can see the image displayed on the LCD 6 formed beneath the touch tablet 6A.

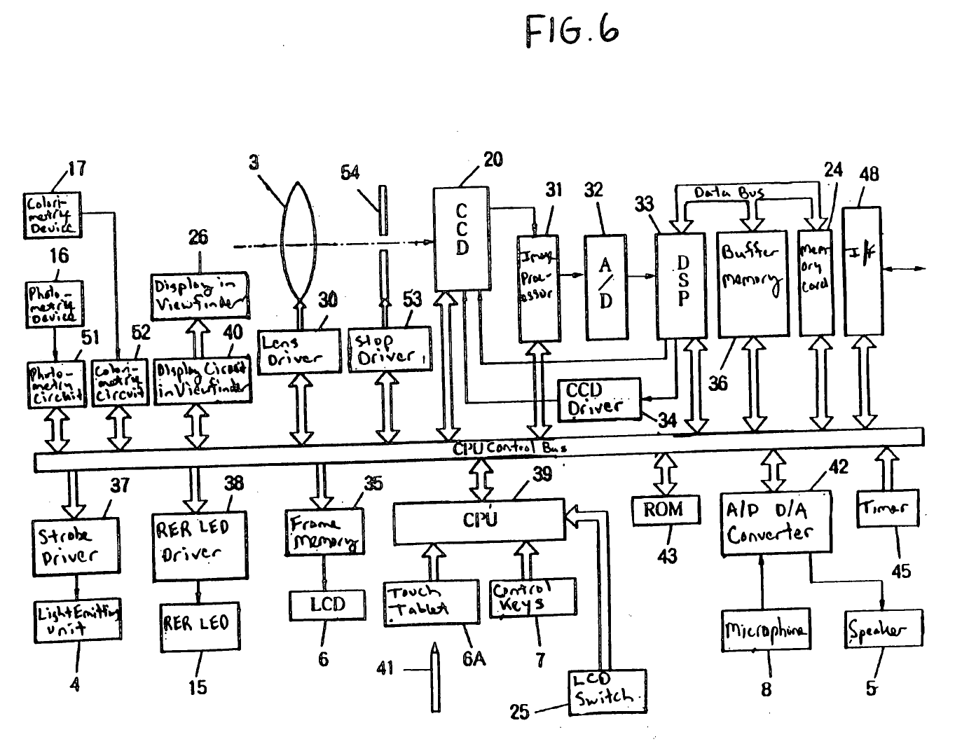

The operation keys 7 are used, for example, when reproducing the recorded data and displaying it on the LCD 6. The operation (input) through the operation keys 7 by the user is detected, and the detection result is supplied to a CPU 39 (FIG. 6).

Among the operation keys 7, menu key 7A is used to display a menu screen on the LCD 6. An execution key 7B is operated to reproduce the recorded information selected by the user. Cancel key 7C is used when cancelling the reproduction process of the recorded information, and delete key 7D is operated for deleting the recorded information. Scroll keys 7E-7H are used to scroll the screen up and down when the list of the recorded information is displayed on the LCD 6.

A slidable LCD cover 14 is also provided on Face X2 to protect the LCD 6 when it is not in use. The LCD cover 14 is slidable in the longitudinal direction of Face X2, and it covers the LCD 6 and the touch tablet 6A when in the protective (closed) position, as shown in FIG. 3. When the LCD cover 14 is slid down, the LCD 6 and the touch tablet 6A are exposed, and at the same time, the arm 14A of the LCD cover 14 turns on the power source switch 11 (described below) formed on Face Y2.

The top surface of the electronic camera 1 is referred to as Face Z. A microphone 8 for collecting sound and an earphone jack 9 for connection with an earphone (not shown) are provided on Face Z.

Face Y1, which is located on the left as viewed from the front Face X1, has a release switch 10 that is operated when photographing the object and a continuous photographic mode changeover switch 13 for changing over the continuous photographic mode during photographing. The release switch 10 and the continuous photographic mode changeover switch 13 are positioned below the viewfinder 2, photographic lens 3 and flash lamp 4 provided on the top part of Face X1.

Face Y2, which is the opposite side of Face Y1 (located on the right as viewed from the front Face X1), has a recording switch 12 for recording sound and a power source switch 11. Similar to the release switch 10 and continuous photographing mode changeover switch 13 formed on Face F1, the recording switch 12 and power source switch 11 are also positioned below the viewfinder 2, photographic lens 3 and flash lamp 4 formed on the top part of Face X1. The recording switch 12 is formed at substantially the same level as the release switch 10 in a symmetrical manner so that the camera can be held by the user with either hands without inconvenience.

Alternatively, the positional levels of the recording switch 12 and release switch 10 may be different. If this is the case, when the user depresses one of the switches and strongly supports the opposite face of the camera with his fingers against the depressing force, a situation in which the other switched is depressed by mistake can be avoided.

The continuous photographing mode changeover switch 13 allows the user to switch over the photographing modes between single frame photographing and multiple frame photographing (continuous photographing of a plurality of frames). If the pointer of the switch 13 is positioned at “S” (S mode), photographing is performed for a single frame upon depressing the release switch 10. If the release switch 10 is depressed in the state in which the indicator of the continuous photographing mode changeover switch 13 is positioned at position “L” (L mode), then photographing is performed of eight frames a second during the depression of the release switch 10. This is called a low-speed continuous photographing mode. If the release switch 10 is depressed in the state in which the indicator of the continuous photographing mode changeover switch 13 is positioned at position “H” (H mode), then photographing is performed of thirty frames a second during the depression of the release switch 10. This is called a high-speed continuous photographing mode.

FIG. 4 shows the interior structure of the electronic camera 1 shown in FIGS. 1 and 2. CCD 20 is provided behind the photographic lens 3 (closer to Face X2), and converts the optical image formed through the photographic lens 3 into electric (image) signals through photoelectric conversion. Photoelectric converters other than a CCD could be used with the invention. For example, CMOS devices or PSDs (Photo-Sensitive-Diodes) could be used as a photoelectric converter.

Indicator 26 is provided within the viewfinder 2, i.e., within the viewing field of the viewfinder 2, to indicate the current state of various functions of the camera 1 to the user who is watching the object through the viewfinder 2.

Below the LCD 6, four cylindrical batteries (for example, AA dry cells) 21 are inserted vertically in parallel. Electric charge stored in the batteries 21 is supplied to each unit of the camera 1. Capacitor 22, which stores electric charge for flash firing of the flash lamp 4, is positioned below the LCD 6.

The electronic camera 1 has a circuit board 23 mounted inside, on which various control circuits are formed to control each part of the electronic camera 1. A removable memory card 24 is inserted between the circuit board 23 and the LCD 6 and batteries 21. Various information input to the electronic camera 1 is recorded in predetermined areas of the memory card 24. Although, in this embodiment, the memory card 24 is removable, a memory may be formed on the circuit board 23 so that various information can be recorded in that memory. The information recorded in the memory (or memory card 24) may be output through an interface 48 to, for example, an external personal computer.

LCD switch 25 is positioned adjacent to the power source switch 11. The LCD switch 25 is turned on only when its plunger is depressed downward. When the LCD cover 14 is slid downward, the arm 14A of the LCD cover 14 depresses the plunger of the LCD switch 25 and the power source switch 11 downward to turn them on.

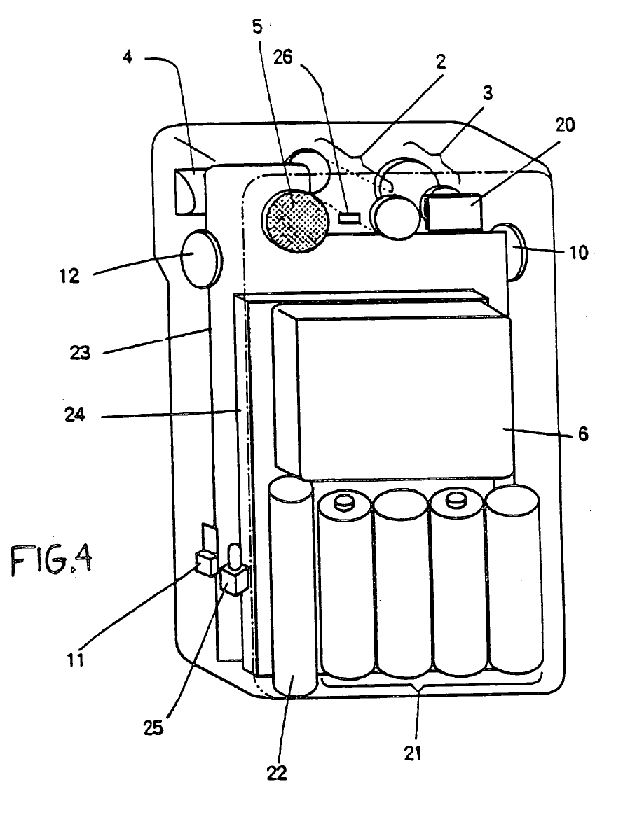

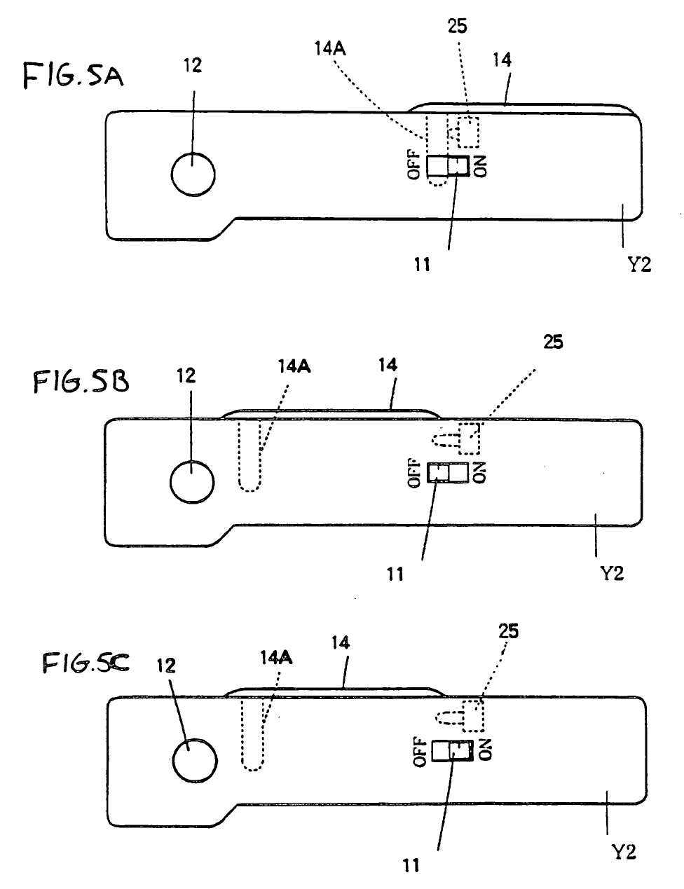

When the LCD cover 14 is positioned upward, the power source switch 11 can be manually operated by the user, separately from the LCD switch 25. For example, when the electronic camera 1 is not in use and the LCD cover 14 is at the closed position, both the power source switch 11 and the LCD switch 25 are in the OFF state, as shown in FIG. 5B. In this situation, if the user manually turns on the power source switch 11, then the power source switch 11 is placed in the ON state, while maintaining the LCD switch 25 in the OFF state, as shown in FIG. 5C. On the other hand, when the LCD cover 14 is opened from the closed position of FIG. 5B (with both switches off), then the power source switch 11 and the LCD switch 25 are turned on, as shown in FIG. 5A. If the LCD cover 14 is closed in this state, only the LCD switch 25 is turned off (FIG. 5C).

An example of the internal electric structure of the electronic camera 1 will be explained referring to FIG. 6. The CCD 20 includes a plurality of pixels and performs photoelectric conversion to convert the optical image formed on each pixel to an image signal (electric signal). Digital signal processor (DSP) 33 supplies a CCD horizontal pulse to the CCD 20, and at the same time, controls the CCD driving circuit 34 so that the CCD driving circuit 34 supplies a CCD vertical pulse to the CCD 20.

Image processor 31, which is controlled by the CPU 39, samples the image signal photoelectrically converted by the CCD 20 with a predetermined timing and amplifies the sampled signal to a prescribed level. The CPU 39 controls each component in accordance with one or more control programs stored in the ROM (read only memory) 43. Analog-to-digital (A/D) converter 32 digitizes the image signal sampled by the image processor 31 and supplies the digital signal to the DSP 33.

The DSP 33 controls the data bus connected to the buffer memory 36 and memory card 24, so that the image data supplied to the DSP 33 from the A/D converter 32 is temporarily stored in the buffer memory 36, read out from the buffer memory 36, and then recorded in the memory card 24.

The DSP 33 also has the image data supplied from the A/D converter 32 stored in the frame memory 35 and displayed on the LCD 6. Furthermore, the DSP reads out the photographed image data from the memory card 24, expands (decompresses) the photographed image data, and has the expanded data stored in the frame memory 35 and displayed on the LCD 6.

When starting the electronic camera 1, the DSP 33 repeatedly activates the CCD 20, while adjusting the exposure time (exposure value), until the exposure level of the CCD 20 reaches a proper level. Alternatively, the DSP 33 may first activate the photometry circuit 51, and then calculate the initial value of the exposure time of CCD 20 in response to the photoreceptive level detected by the photometry element 16. This can reduce the exposure adjusting time of CCD 20.

The DSP also controls data input/output timing, including data recording in the memory card 24 and storage of the expanded data in the buffer memory 36.

The buffer memory 36 is used to accommodate the difference between the data input/output speed to/from the memory card 24 and the processing speed of the CPU 39 and DSP 33.

Microphone 8 is used to input audio information (i.e., to collect sound). The audio information is supplied to the A/D and D/A converter 42. The A/D and D/A converter 42 converts the analog signal corresponding to the sound detected by the microphone 8 to a digital signal, and supplies the digital signal to the CPU 39. The A/D and D/A converter 42 also converts the digital signal supplied from the CPU 39 to an analog signal, and outputs the analog audio signal through the speaker 5.

Photometry element 16 measures the light quantity of the (photographic) subject and the surroundings, and outputs the measurement result to the photometry circuit 51. The photometry circuit applies a prescribed process to the analog signal, which is the photometry result supplied by the photometry element 16, and then converts the processed analog signal to a digital signal for output to the CPU 39.

Color measuring (colorimetry) element 17 measures a color temperature of the subject and the surroundings, and outputs the measurement result to the color measuring (colorimetry) circuit 52. The color measuring circuit 52 applies a prescribed process to the analog signal, which is the color-measurement result supplied by the color measuring element 17, and then converts the processed analog signal to a digital signal for output to the CPU 39.

Timer 45 has a built-in clock circuit to output the data representative of the current time (date and time) to the CPU 39.

Stop driving circuit (driver) 53 is designed so as to set the aperture diameter of the stop 54 to a predetermined value. The stop 54 is positioned between the photographic lens 3 and the CCD 20, and alters the aperture of light entering the CCD through the photographic lens 3.

The CPU 39 controls the actions of the photometry circuit 51 and the color measuring circuit 52 in response to the signal supplied from the LCD switch 25. When the LCD cover 14 is open, the CPU 39 stops the operations of the photometry circuit 51 and the color measuring circuit 52. When the LCD cover 14 is open, the CPU 39 activates the photometry circuit 51 and the color measuring circuit 52, while suspending the action of the CCD 20 (e.g., action of the electronic shutter) until the release switch 10 reaches the half-depressed state.

The CPU 39, during suspension of the action of the CCD 20, controls the photometry circuit 51 and the color measuring circuit 52 and receives the photometry result of the photometry element 16 and the color measuring result of the color measuring element 17. Then, the CPU 39 calculates a white balance adjusting value corresponding to the color temperature supplied from the color measuring circuit using a prescribed table. The white balance adjusting value is supplied to the image processor 31.

In other words, when the LCD cover 14 is closed, the CCD 20 is not activated because the LCD 6 is not used as an electronic viewfinder. Since the CCD 20 consumes a large amount of electric power, suspension of the operation of the CCD 20 contributes to power saving of the battery 21.

When the LCD cover 14 is closed, the CPU 39 controls the image processor 31 not to execute processing until the release switch 10 is operated (until the release switch 10 reaches the half-depressed state).

The CPU 39 also controls the stop driving circuit 53 when the LCD cover 14 is closed, not to change the aperture diameter of the stop 54 until the release switch 10 is operated (until the release switch 10 reaches the half-depressed state).

The CPU controls the strobe driving circuit (driver) 37 to fire the strobe lamp 4 in appropriate timing, in addition to controlling the red-eye reduction LED driving circuit (driver) 38 to appropriately trigger the red-eye reduction LED 15 prior to firing the strobe lamp 4.

When the LCD cover 14 is open, (i.e., when the electronic viewfinder is in use), the CPU 39 can prevent the strobe lamp 4 from being fired. This allows the object to be photographed in the same state as it is displayed in the electronic viewfinder.

The CPU 39 records the information about the photographing date according to the time data supplied from the timer 45, as header information of the image data, in the photographed image recording area of the memory card 24. (That is, the photographed image data recorded in the photographed image recording area of the memory card 24 contains photographing time data.)

After sound information is digitized and compressed, the CPU 39 has the compressed audio data stored in the buffer memory 36 temporarily. The data then is recorded in a predetermined area (audio data recording area) of the memory card 24. At this time, recording time data is recorded, as header information of audio data, in the audio recording area of the memory card 24.

The CPU 39 controls the lens driving circuit (driver) 30 to appropriately move the photographic lens 3, thereby performing autofocus operations. The CPU 39 further controls the stop driving circuit 53 to change the aperture diameter of the stop 54 positioned between the photographic lens 3 and the CCD 20.

The CPU controls the viewfinder display circuit 40 to display the setting states of various actions on the viewfinder display device 26.

The CPU 39 executes prescribed data transmission/receipt to/from external equipment (not shown) through interface (I/F) 48.

The CPU 39 receives signals from operation keys 7 and processes the signals appropriately. When touch tablet 6A is contacted through pen (pen-type pointing device) 41 operated by the user, the X-Y coordinates of the contacted position on the touch tablet 6A is read by the CPU 39. The coordinate data (which is memo information described below) is stored in the buffer memory 36. The CPU 39 reads out the memo information stored in buffer memory 36, and records it together with header information of memo information input time in the memo information recording area of the memory card 24.

Operations of the electronic camera 1 according to the embodiment will be described. First, explanation is made on the operation of the electronic viewfinder of LCD 6.

When the user half-depresses the release switch 10, the DSP 33 determines whether or not the LCD cover 14 is open based on the signal value supplied from the CPU 39. The signal value corresponds to the state of the LCD switch 25. If it is determined that the LCD cover 14 is closed, no electronic viewfinder operation is performed. If this is the case, the DSP 33 suspends processing until the release switch 10 is operated.

Because electronic viewfinder operation is not executed when the LCD cover 14 is closed, the CPU 39 suspends the operations of the CCD 20, image processor 31 and stop driving circuit 53. In this situation, the CPU 39 activates the photometry circuit 51 and color measuring circuit 52, and supplies the measurement results to the image processor 31. The image processor 31 uses the measurement results when controlling the white-balance or brightness.

When the release switch is operated, then the CPU 39 activates the CCD 20 and the stop driving circuit 53.

On the other hand, if it is determined that the LCD cover 14 is open, then the CCD 20 performs an electronic shutter action at predetermined time intervals for a predetermined exposure time, and photoelectrically converts the optical image of the object collected by the photographic lens 3 to an electric signal. The image signal obtained through such photoelectric conversion is output to the image processor 31.

The image processor 31 controls the white balance and brightness. The image processor 31 applies a prescribed process to the image signal, and then outputs the image signal to the A/D converter 32. If the CCD 20 is being activated, then the image processor 31 uses an adjustment value calculated based on the output of the CCD 20 for controlling the white balance and brightness.

The A/D converter 32 converts the analog image signal to digital image data, and outputs the digital data to the DSP 33. The DSP 33 outputs the digital image data to the frame memory 35 to have the LCD 6 display the image corresponding to the digital image data.

Thus, when the LCD cover 14 is open in the electronic camera 1, the CCD 20 performs electronic shutter actions periodically. Every time the CCD 20 performs the shutter action, the signal output from the CCD 20 is converted to digital image data, which is then output to the frame memory 35 to have the LCD 6 continuously display the object image. This is the function of the electronic viewfinder.

When the LCD cover 14 is closed, electronic viewfinder action is not executed. If this is the case, operations of the CCD 20, image processor 31, and stop driving circuit 53 are suspended to save power consumption.

Next, photographing operations using the apparatus of the invention will be described.

First, explanation will be made of S mode photographing, in which the continuous photographing mode changeover switch 13 provided on Face Y1 is set to the S mode (photographing a single frame). The power source switch 11 shown in FIG. 1 is shifted to the “ON” side to turn on the power source of the electronic camera 1. The object can be checked through the viewfinder 2 before the release switch 10 provided on Face Y1 is depressed. A photographing process starts upon depression of the release switch 10.

If the LCD cover 14 is closed, the CPU 39 activates the CCD 20, image processor 31 and diaphragm driving circuit 53 at the point of time when the release switch 10 is halfway depressed, and starts the photographing process when the release switch reaches the full-depressed state.

The optical image of the object observed through the viewfinder 2 is collected by the photographic lens and is imaged on the CCD 20, which includes a plurality of pixels. The optical image formed on the CCD 20 is photoelectrically converted to an image signal at each pixel, and sampled by the image processor 31. The sampled image signal is supplied from the image processor 31 to the A/D converter 32 for digitization. The digital signal is output to the DSP 33.

The DSP 33 supplies the digital image data to the buffer memory for temporary storage, reads the image data out of the buffer memory 36, and compresses the data using the JPEG (Joint Photographic Experts Group) method, which combines discrete cosine transformation, quantization and Huffman encoding. The compressed data is recorded in the photographed image recording area of the memory card 24. At this time, data representing the photographing time is also recorded as header information of the photographed image data in the photographed image recording area of the memory card 24.

Since the continuous photographing mode changeover switch 13 is set to the S mode, a single frame is photographed. Even if the release switch 10 is continuously depressed, subsequent photographing is not performed. If the release switch 10 is continuously depressed with the LCD cover 14 open, the photographed image (a single frame) is displayed on the LCD 6.

Second, explanation will be made of the case in which the continuous photographing mode changeover switch 13 is set to the L mode (continuously photographing 8 frames per second). Power source switch 11 is switched on to turn on the power source of the electronic camera 1, and then the release switch 10 provided on Face Y1 is depressed to start a photographing process.

If the LCD cover 14 is closed, the CPU 39 activates the CCD 20, image processor 31 and stop driving circuit 53 at the point of time when the release switch 10 is halfway depressed, and starts the photographing process when the release switch reaches the full-depressed state.

The optical image of the object observed through the viewfinder 2 is collected by the photographic lens and is imaged on the CCD 20. The optical image formed on the CCD 20 is photoelectrically converted to an image signal at each pixel, and sampled by the image processor 31 eight times per second. At this time, the image processor 31 thins out three-quarters of the pixels from the image signals of all of the pixels of CCD 20. The image processor 31 divides the pixel matrix of the CCD 20 into multiple areas, each area consisting of 2×2 pixels (four pixels), as shown in FIG. 7.

Among the four pixels composing an area, the image signal of a predetermined pixel is sampled, and the remaining three pixels are thinned out (ignored).

For example, at the first sampling (for the first frame), the top left pixel “a” of each area is sampled, and the other pixels “b”, “c” and “d” are thinned out. At the second sampling (for the second frame), the top right pixel “b” of each area is sampled, and the pixels “a”, “c” and “d” are thinned out. At the third and fourth sampling, the bottom left pixel “c” and bottom right pixel “d” are sampled, respectively, and the other pixels are thinned out. In other words, each pixel is sampled every four frames.

The image signals sampled by the image processor 31 (which are the signals of a quarter of the pixels of CCD 20) are supplied to the A/D converter 32 for digitization. The digital image data is output to the DSP 33.

The DSP 33 outputs the digitized image signal to the buffer memory for temporary storage, then reads out the digital image signal, and compresses the digital signal using the JPEG method. The digitized and compressed image data is recorded in the photographed image recording area of the memory card 24. Data representing the photographing time is also recorded in the photographed image recording area of the memory card 24 as header information of the photographed image data.

Third, explanation will be made of the case in which the continuous photographing mode changeover switch 13 is set to the H mode (continuously photographing 30 frames a second). Power source switch 11 is switched on to turn on the power source of the electronic camera 1, and then the release switch 10 provided on Face Y1 is depressed to start a photographing process.

If the LCD cover 14 is closed, the CPU 39 activates the CCD 20, image processor 31 and stop driving circuit 53 at the point of time when the release switch 10 is halfway depressed, and starts the photographing process when the release switch reaches the full-depressed state.

The optical image of the object observed through the viewfinder 2 is collected by the photographic lens and is imaged on the CCD 20. The optical image formed on the CCD 20 is photoelectrically converted to an image signal at each pixel, and sampled by the image processor 31 thirty times per second. At this time, the image processor 31 thins out eight-ninths of the pixels from the image signals of all of the pixels of CCD 20.

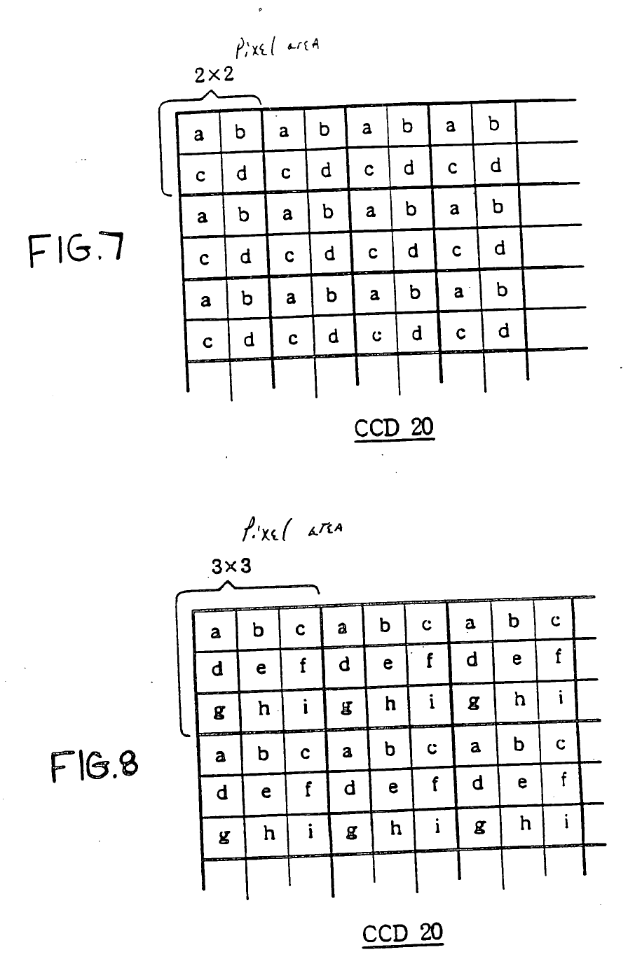

The image processor 31 divides the pixel matrix of the CCD 20 into multiple areas, each area consisting of 3×3 pixels (nine pixels), as shown in FIG. 8. Among the nine pixels composing an area, the image signal of a predetermined pixel is sampled, and the remaining eight pixels are thinned out. The sampling is performed 30 times per second.

For example, at the first sampling (for the first frame), the top left pixel “a” of each area is sampled, and pixels “b” through “i” are thinned out. At the second sampling (for the second frame), the pixel “b” positioned on the right side of pixel “a” is sampled, while pixels “a” and “c”-“i” are thinned out. At the third and later sampling, pixel “c”, “d” . . . and “i” are sampled, respectively, and the other pixels are thinned out. In other words, each pixel is sampled every four frames.

The image signals sampled by the image processor 31 (which are the signals of one-ninth of the pixels of CCD 20) are supplied to the A/D converter 32 for digitization. The digital image data is output to the DSP 33. The DSP 33 outputs the digitized image signal to the buffer memory for temporary storage, then reads out the digital image signal, and compresses the digital signal using the JPEG method. The digitized and compressed image data is recorded in the photographed image recording area of the memory card 24, together with header information representing the photographing date.

Strobe lamp 4 may be activated to illuminate the object, as necessary. However, when the LCD cover 14 is open, that is, when the LCD 6 is conducting the electronic viewfinder operation, then the CPU 39 can control the strobe lamp 4 not to emit light.

Next, explanation will be made of the operations performed when two-dimensional information (pen-input information) is input through the touch tablet 6A.

When the touch tablet 6A is contacted by the tip of the pen 41, the X-Y coordinates of the contacted positions are input to the CPU 39. The X-Y coordinates are stored in the buffer memory. The data can also be written in the frame memory 35 at positions corresponding to that X-Y coordinates, thereby displaying the memo corresponding to dragging of the pen 41 on the X-Y coordinates of the LCD 6.

As has been described, the touch tablet 6A is made of transparent material, and the user can observe the point displayed on the LCD 6 (corresponding to the position contacted by the tip of the pen 41) in real time. This allows the user to feel as if the user directly input the memo onto the LCD 6 using the pen. When the user moves the pen 41 on the touch tablet 6A, a line is displayed on the LCD 6 in response to the movement of the pen 41. If the pen 41 is moved off and on the touch tablet 6A, a broken line is displayed on the LCD 6. Thus, the user can input desired memo information including any characters or drawings on the touch tablet 6A.

If memo information is input through the pen 41 while displaying a photographed image on the LCD 6, the memo information and the photographed image information are synthesized (combined) in the frame memory 35, and displayed simultaneously on the LCD 6.

The user can select the color of the memo from among black, white, red, blue, etc. by operating a pallet.

After memo information is input through the pen 41 to the touch tablet 6A, when the execution key 7B of the operation keys 7 is pushed, then the memo information stored in the buffer memory 36 is supplied to the memory card 24 together with the header information representing the input time and recorded in the memo information recording area of the memory card 24.

The memo information recorded on the memory card 24 preferably is subjected to data compression. Because the memo information input to the touch tablet 6A contains information having a high spatial frequency component, the amount of the memo information can not be adequately reduced by data compression using the JPEG method, which is used for compression of photographed image. This would result in insufficient compression efficiency, and as a result, time taken for compression and expansion becomes long. Furthermore, since the JPEG compression is lossey compression, it is not suitable to compression of memo information that contains a small amount of information (because, when expanded and displayed on the LCD 6, gathering or blurring due to information gaps becomes conspicuous).

Therefore, in this embodiment, memo information is compressed using the run-length encoding method used in, for example, facsimile machines. Run-length encoding is a method for compressing memo information by scanning the memo in the horizontal direction and encoding each continuous length of information areas (dots, points) of each color, such as black, white, red, blue, and each continuous length of non-information areas (spaces without having pen input). Memo information can be compressed to a minimum using the run-length method. Furthermore, during expansion of the compressed memo information, information gaps can be suppressed. If the amount of memo information is very small, it need not be compressed.

As has been described, when memo information is input through the pen 41 while displaying a photographed image on the LCD 6, then the photographed image data and the memo information are synthesized in the frame memory 35, and a composite image of the photographed image and the memo information is displayed on the LCD 6. Meanwhile, the photographed image data is recorded on the photographed image recording area of the memory card 24, while the memo information is recorded on the memo information recording area of the memory card 24. Because the two different types of information items are recorded in the different areas, the user can delete one of the information (for example, memo information) from the composite image of the photographed image and the memo. In addition, each type of information can be compressed using an individual compression method.

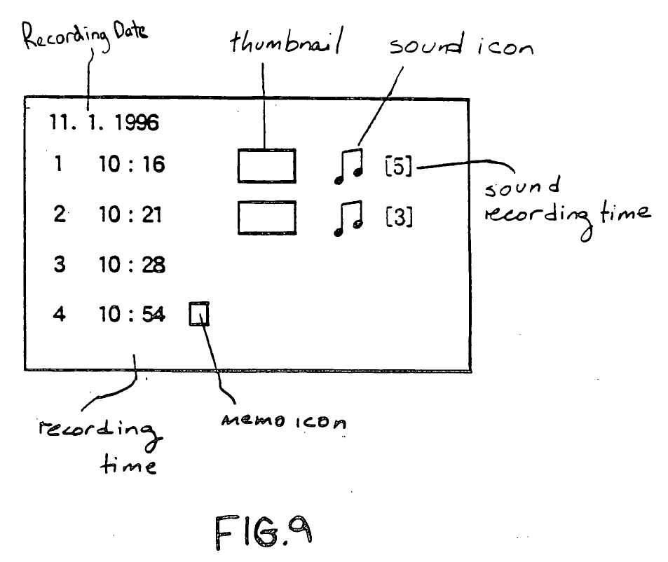

When data is recorded in the sound recording area, photographed image recording area, or memo information recording area, the list of the recorded data can be displayed on the LCD 6, as shown in FIG. 9.

On the display screen of the LCD 6 of FIG. 9, the date of the information recording (e.g., Nov. 1, 1996) is displayed on the top of the screen. Information numbers (corresponding to each item of information) recorded on that date and recording time are listed on the left side of the screen below the recording date.

Thumbnail images are displayed on the right side of the recording time. The thumbnail images are created by thinning out (reducing) the bit map data of each photographed image data recorded in the memory card 24. In the list, those information items having a thumbnail image contain photographed image data. That is, the information items input at 10:16 and 10:21 contain photographed image data, and the information items input at other times do not contain image data.

The memo icon (white square) indicates that a memo is recorded as line drawing information in a particular information item.

On the right of the thumbnail, a sound icon (musical note) is displayed together with the sound recording time (in seconds). If there is no sound information input, then these items are not displayed.

The user can select a desired sound icon from the list displayed on the LCD 6 by touching the icon with the pen 41. The selected sound is reproduced by touching the execution key 7B (FIG. 2) with the tip of the pen 41.

For example, if the sound icon of the first information item recorded on “10:16” is touched by the pen 41, then the CPU 39 reads out the audio data corresponding to the recording time (10:16) from the memory card 24, expands the audio data, and supplies it to the A/D and D/A converter 42. The A/D and D/A converter 42 converts the supplied audio data to an analog signal and reproduces the sound through the speaker 5.

When reproducing a photographed image recorded in the memory card 24, the user selects a desired thumbnail by touching it with the pen 41, and then pushes the execution key 7B for reproduction of the image. The CPU 39 instructs the DSP 33 to read out the photographed image data corresponding to the recording time of the selected thumbnail from the memory card 24. The DSP 33 expands the (compressed) photographed image data read out from the memory card 24, and has the expanded data stored in the frame memory 35 as bit map data and displayed on the LCD 6.

The image photographed in the S mode is displayed on the LCD 6 as a still image. The still image is reproduced by reproducing image signals of all of the pixels of the CCD 20. The images photographed in the L mode are continuously displayed on the LCD 6 (i.e., as a moving picture) at a rate of 8 frames per second. The number of pixels displayed in each frame is a quarter of the pixels of the CCD 20.

Generally, human eyes sensitively react to the deterioration in the resolution of a still image. Therefore, if pixels are thinned out in a still image, it is noticeable by users and regarded as deterioration of the image quality. However, if 8 frames are photographed per second in the L mode with high continuous photographing speed, and if those images are reproduced at a rate of 8 frames per second, then, the human eyes will observe 8 frames of images per second. As a result, although the number of pixels of each frame is a quarter of the pixels of the CCD 20, the information amount coming into the human eyes per second becomes double, as compared with a still image.

Assuming that the number of pixels composing a frame of image photographed in the S mode is 1, then the number of pixels used for a frame of image photographed in the L mode becomes ¼. When the image photographed in the S mode (still image) is displayed on the LCD 6, the information amount per second coming into the human eyes is 1=(1 pixel)×(1 frame). On the other hand, when the images photographed in the L mode are displayed on the LCD 6, then the information amount per second coming into the human eyes becomes 2=(¼ pixels)×(8 frames). Thus, double amount of information reaches the human eyes. Therefore, even if the number of pixels is made ¼, the user can observe the reproduced images without noticing deterioration of the image quality.

Furthermore, in the embodiment, different pixels are sampled and displayed on the LCD 6 for different frames. This causes an after-image effect in the human eyes, and the user can see the images photographed in the L mode without noticing inferiority in the images even if three-quarters of the pixels are thinned out each frame.

The images photographed in the H mode are continuously displayed on the LCD 6 at a rate of 30 frames per second. At this time, the number of pixels displayed for each frame is one-ninth of the total pixels of the CCD 20. However, for the same reasons as the L mode, the user can see the H mode images reproduced on the LCD 6 without noticing a change in the image quality.

In the embodiment, when photographing the object in the L and H modes, the image processor 31 thins out pixels of the CCD 20 so that the deterioration of the reproduced image quality is not noticed by the user. This can reduce the load on the DSP 33 and allow the DSP 33 to be used at a low speed and with a low electric power.

Thus, the cost of the apparatus and the power consumption can also be reduced. As has been described, in this embodiment, the apparatus is capable of not only photographing optical images of an object, but also recording memo (line drawing) information. The apparatus has the corresponding modes (photographing mode and memo input mode), which are appropriately selected through the user's operation, whereby information can be smoothly input to the apparatus.

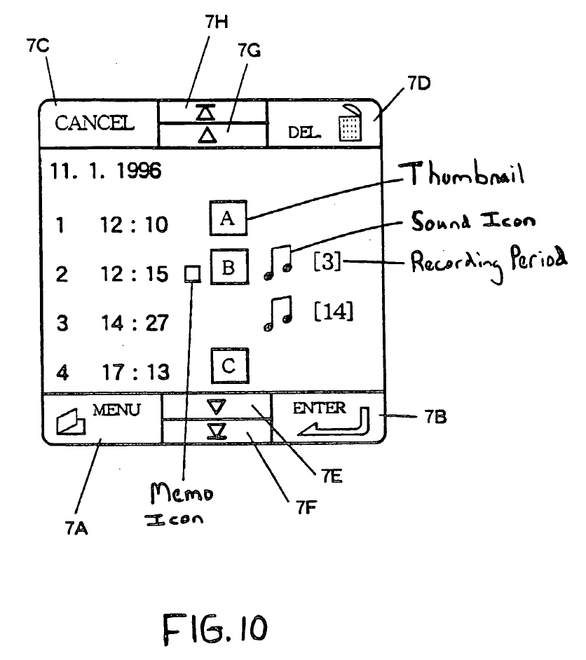

FIG. 10 shows another example of the display screen of the LCD 6 displaying the list of the information recorded in the memory card 24. The top left of the screen shows the recording date, followed by the recording list displayed in the time series manner. The list contains information (item) number, recording time, memo icon, thumbnail image, sound icon, and sound recording time in this order from the left.

Now, explanation will be made of a case in which a plurality of information of different recording times are selected and displayed on the screen by selecting the execution key 7B. For example, the information numbers 1 through 4 are selected and displayed on the screen by selecting the execution key 7B.

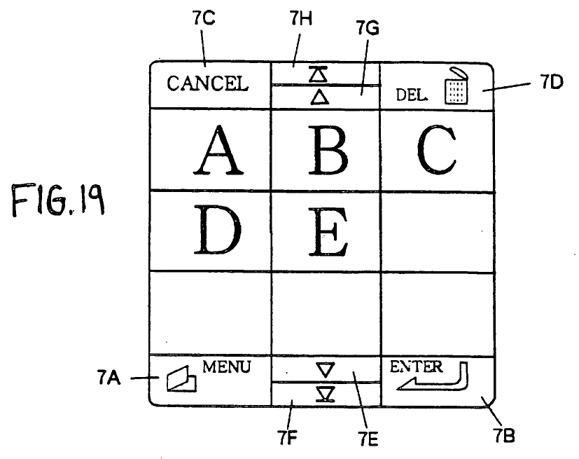

FIG. 11 shows an example of the screen of the LCD 6 displaying multiple selected information. The CPU 39 divides the screen of the LCD 6 into a plurality of areas based on the number of selected information. The method for dividing the screen into a plurality of areas corresponding to the number of selected information is described later with reference to the flow chart of FIG. 18. In this example, because four information, three of which contain image data, are selected, the screen of the LCD 6 is divided into four areas. In this example, regarding the second information item, which contains both image and sound information, the CPU only displays the image on the screen, ignoring the sound. The CPU 39 also ignores the third information in which only sound information is recorded.

The CPU 39 reads the image data corresponding to the thumbnail image of the first information item out of the memory card 24, reduces the image in size by thinning out some of the pixels so that it corresponds to the size (the number of pixels) of the divided screen area of the LCD 6, and writes the reduced image in a corresponding area of the frame memory 35. Then, the CPU 39 reads the image data corresponding to the thumbnail of the second information item out of the memory card 24, reduces the size of the image in the same manner, and writes it in a corresponding part of the frame memory 35. Regarding the third information item, since it contains only sound information, it is ignored. The image corresponding to the thumbnail image of the fourth information item is read out from the memory card 24, reduced in size in the same manner, and written in the corresponding area in the frame memory.

Thus, image A of the first information item, image B of the second information item, and image C of the fourth information item are displayed in the divided area of the screen in the arrangement shown in FIG. 11.

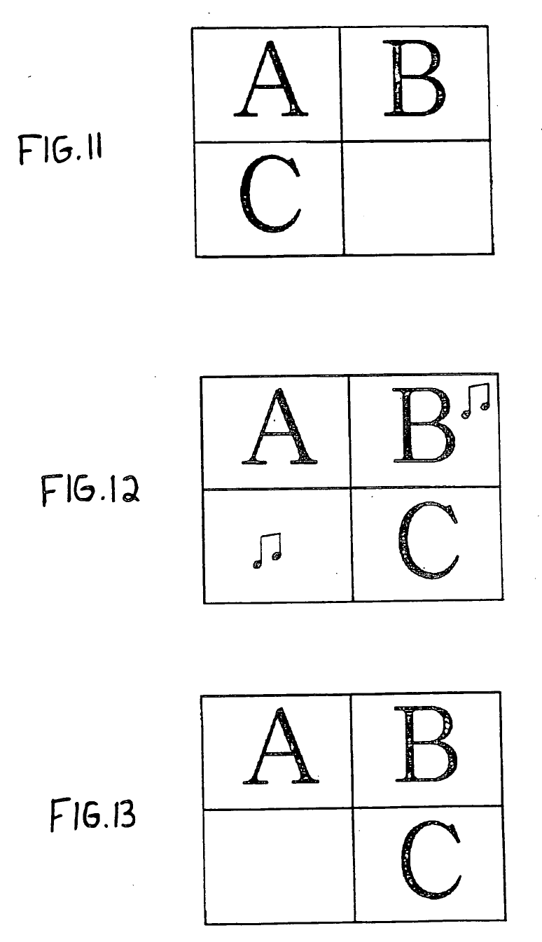

FIG. 12 shows another example of the screen of the LCD 6 displaying a plurality of information. The CPU 39 divides the screen of the LCD 6 into a plurality of areas based on the number of the selected information items. The screen of the LCD 6 is divided into four because four information items have been selected. In this example, the CPU 39 displays a symbol (e.g., a musical note) representing audio data for the information items containing sound information so as to indicate the existence of the sound information.

The CPU 39 reads out the image corresponding to the thumbnail image of the first information item from the memory card 24, reduces the image size by, for example, thinning out a portion of pixels to the extent of the size (the number of pixels) of the divided screen area of the LCD 6, and writes it in a corresponding area of the frame memory 35. Then, the CPU 39 reads the image corresponding to the thumbnail image of the second information item out of the memory card 24, reduces the image in size in the same manner, and writes it in a corresponding area of the frame memory 35. Since the second information item contains sound information, a musical note also is written in the predetermined position of the frame memory to indicate the existence of sound information. The third information item contains only sound information, and so only a musical note indicating the existence of sound information is written in a predetermined position of the frame memory 35. Finally, the image corresponding to the thumbnail image of the fourth information item is read out from the memory card 24, reduced in the same manner, and written in a corresponding area of the frame memory 35.

The four divided areas of the screen display image A of the first information item, image B of the second information item together with a musical note, a musical note corresponding to the third information item, and image C of the fourth information item, respectively, as shown in FIG. 12.

FIG. 13 shows still another example of the screen of the LCD 6 displaying a plurality of information. The CPU 39 divides the screen of the LCD 6 into multiple areas based on the number of the selected information items. The screen is divided into four areas based on the four selected information items. In this example, the CPU 39 instructs so that no symbols are displayed in connection with sound information.

The CPU 39 reads the image data corresponding to the thumbnail image of the first information item out of the memory card 24, reduces the image in size by thinning out a portion of the pixels so that it corresponds to the size (the number of pixels) of the divided screen area of the LCD 6, and writes it in a corresponding area of the frame memory 35. Then, the CPU 39 reads the image data corresponding to the thumbnail image of the second information item out of the memory card 24, reduces the size of the image in the same manner, and writes it in a corresponding part of the frame memory 35. Although the second information contains sound information, no symbol indicating the existence of the sound information is displayed in this example. Since the third information item contains only sound information, nothing is written in a corresponding area of the frame memory 35.

The image corresponding to the thumbnail image of the fourth information item is read out from the memory card 24, reduced in size in the same manner, and written in a corresponding area in the frame memory.

Thus, the four divided areas of the screen display image A of the first information item, image B of the second information item, a blank image indicating no photographed image but sound information contained, and image C of the fourth information item, respectively, as shown in FIG. 13.

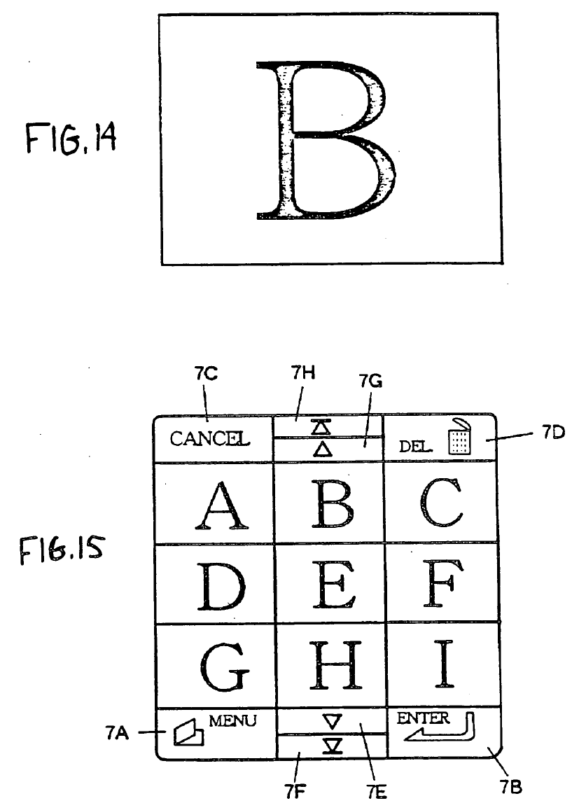

In the state in which the area-divided screen of the LCD 6 displays images as shown in FIGS. 11-13, if the user selects, for example, image B using pen 41 and touches the execution key 7B, then the CPU 39 has the selected image B displayed on the entire screen, as shown in FIG. 14. Since image B has associated sound information (see the list of FIG. 10), the CPU 39, after image B is displayed on the entire screen, reads the audio data from the memory card 24 and supplies it to the A/D and D/A converter 42. The A/D and D/A converter 42 converts the digital audio data supplied from the CPU 39 to an analog sound signal, and supplies the analog signal to the speaker 5. In this way, the sound associated with the image B displayed on the LCD 6 is output through the speaker 5.

It is possible for the user to select five or more information items from the list of FIG. 10. If the number of information selected by the user is from 5 to 9, then the CPU 39 divides the screen of LCD 6 into nine areas. If ten information items are selected, the CPU 39 also divides the screen into nine areas, and has nine out of ten information items displayed on the screen. In view of the screen size of the LCD 6, if the screen is divided into ten or more areas, each area becomes too small to recognize the image displayed thereon. Therefore, in the present embodiment, dividing the screen into nine is the upper limit. If the screen size of the LCD 6 is adequately large, then the screen can be divided into ten or more areas.

If an external device is connected to the CPU 39 through interface (11F) 48 and information is displayed on a monitor of the external device, then the upper limit of the screen division can be changed according to the monitor size.

An example of a screen display, when more than ten information items are selected from the list of FIG. 10, will be explained below.

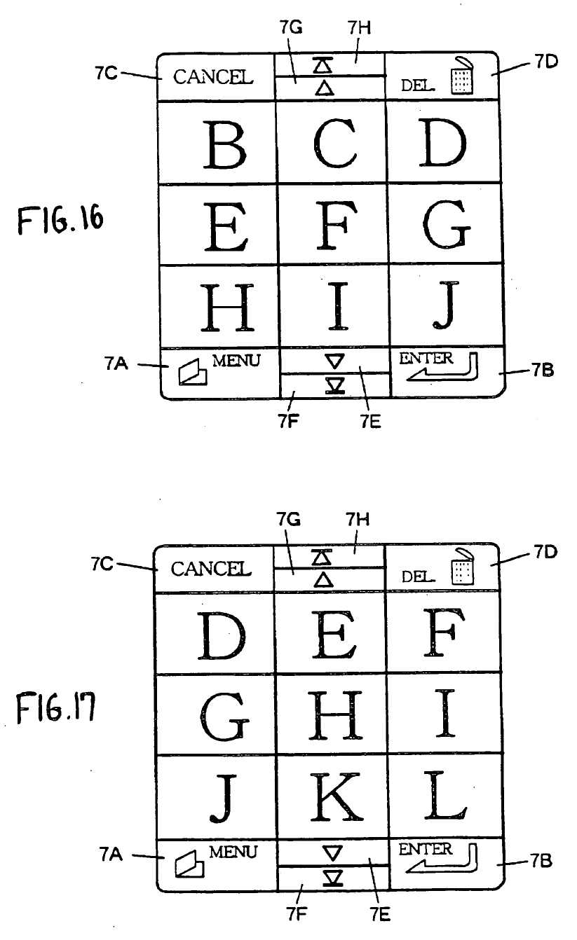

If twelve information items A-L are selected from the list of FIG. 10, followed by selection of the execution key 7B, the CPU 39 determines that dividing into nine is the upper limit for the LCD 6 and divides the screen of the LCD 6 into nine areas. The first nine information items A-I, among the selected information items, are sequentially displayed in the nine areas, as shown in FIG. 15. Then, if scroll key 7E is selected in this state, the CPU 39 controls the screen so that the displayed nine information items are moved up by one and information items B-J appear on the nine areas, as shown in FIG. 16.

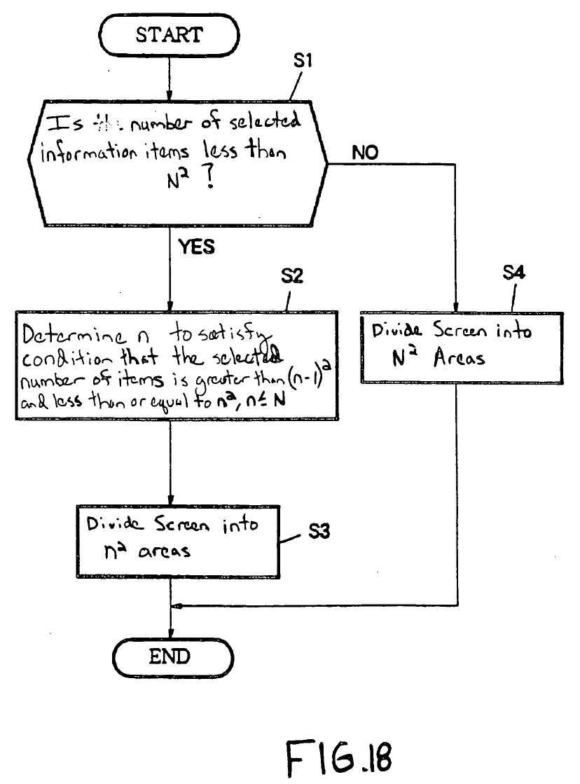

If, in the state of FIG. 15 or 16, scroll key 7F is selected, the CPU 39 controls the screen so that the last nine information items D-L, among the selected information items A-L, are displayed as shown in FIG. 17. On the contrary, if scroll key 7G is selected in the state of FIG. 16, the CPU 39 controls the screen so that the nine information items are moved down in the reverse order and information items A-I are displayed on the screen, as in FIG. 15. If scroll key 7H is selected in the state of FIG. 17 or 16, the CPU 39 controls the screen so that the first nine information items A-I among the selected information items are displayed on the screen.

FIG. 17 shows another example of screen display with more than ten information items selected from the list of FIG. 10. If twelve information items A-L are selected from the list of FIG. 10, followed by selection of the execution key 7B, the CPU 39 determines that dividing into nine is the upper limit for the LCD 6 and divides the screen of the LCD 6 into nine areas. The CPU 39 has the last nine information items D-L, among the selected information items, displayed sequentially in the nine areas, as shown in FIG. 17. Display control using scroll keys is the same as the previous example, so the explanation thereof is omitted.

Regarding sound information, a musical note may be displayed on the screen, or a blank image may be displayed, or that information may be skipped without displaying anything. FIGS. 15 and 16 show examples in which the total number of information items selected to be displayed on the screen is ten or more, including sound information.

If information items that contain memo information is included in the multiple information items selected by the user, it is possible for the apparatus to display the memo in the corresponding area of the divided screen. If memo information is stored in association with image information, the memo can be displayed superimposed onto the photographed image in the corresponding area of the divided screen. If the selected information contains only memo information, the memo can be solely displayed without photographed image on the corresponding area of the divided screen. The size of the divided area of the screen can be set to be larger than that of the thumbnail image shown in the list of FIG. 10. This prevents each image displayed on the divided area from becoming too small to recognize.

Another embodiment of the invention will now be described. In this embodiment, the control operation of the CPU 39 is slightly different from the previous embodiment. The parts forming the electronic camera 1 are the same as the previous embodiment, and the explanation will be omitted. The only difference in the control action of the CPU 39 resides in information selection from the list of FIG. 10.

The control operation of the CPU 39 for information selection from the list of FIG. 10 will be explained below.

In the list of FIG. 10, information is selected by selecting desired numbers of information for example, A, B and C. The CPU 39 controls this action so that up to nine information selections can be accepted. When the user selects the tenth information, the CPU 39 determines that the information can not be displayed on the screen because of the upper limit of the divided areas (9 areas) of the LCD 6 and does not accept the tenth selection.

In this embodiment, all of the selected information items are displayed on the divided areas of the screen at a time. When deleting all of these information, the user can quickly confirm the information to be deleted before deletion because they are all on the screen.

Next, the manner of dividing the screen into a plurality of areas corresponding to the number of selected information items is explained with reference to the flow chart of FIG. 18.

First, in step S1, it is determined whether the number of the selected information items is less than the maximum number N² of areas into which the screen can be divided. At this point, N is a natural number, and the value thereof is predetermined by the size and resolution of the screen. (In the previous examples, N=3.) In short, when an image is displayed on each area of the divided screen, given that the images must be discernible, the value of N increases with larger screen sizes and higher resolutions, since the screen can be divided into more areas. On the contrary, when the resolution of the screen is lower or the size of the screen is smaller, N becomes a smaller value since the screen can be divided into fewer areas.

In step S1, when the number of the selected information items is determined to be less than the maximum value N² into which the screen can be divided, flow proceeds to step S2. In step S2, the CPU 39 determines the value of a variable n such that the number of selected information items is larger than (n−1)² and less than n². Here, n is a natural number which is less than or equal to N. For example, if three items are selected, n=2, whereas if five items are selected, n=3.

Next, in step S3, then the screen is divided into n² areas by the CPU 39.

On the other hand, in step S1, if the number of the selected information items is determined to be greater than or equal to the maximum number N², flow proceeds to step S4, and the CPU 39 divides the screen into N² areas. Then, the process ends when the processing of step S3 or step S4 is completed.

For example, if the number of areas into which the screen which can be divided is nine (=3²) (N=3), and the number of the selected information items is from two to four, the screen is divided into four areas (n=2) as shown in FIGS. 11-13. If the number of the selected information items is more than nine, the screen is divided into nine areas.

FIG. 15 and FIG. 17, as described above, show the case in which more than ten information items are selected, and the screen is divided into nine areas. When from five to nine information items are selected, as shown in FIG. 19, the screen is divided into nine areas, and the selected information is displayed on each area. FIG. 19 shows the display example of the screen when five information items are selected.

As described above, the screen can be divided into the most appropriate number of areas in accordance with the number of selected information items.

The program that causes the CPU 39 to perform, for example, the processing indicated in the flow chart of FIG. 18 can be stored in the ROM 43 or the memory card 24 or the like of the electronic camera 1. Furthermore, this program can be provided to the user in the condition of being pre-stored in the above mentioned ROM 43 or memory card 24, or can be provided to the user in the condition of being stored in a CD-ROM (compact disk-read only memory) or the like and copied to the ROM 43 or the memory card 24. In that case, the ROM 43, for example, can be an EEPROM (electrically erasable and programmable read only memory) or the like. The program also can be supplied to the user via a communications network such as, for example, the Internet (World Wide Web).

In the described embodiment, the number of divided areas is set to four (4) or nine (9). However, the screen can be divided into more areas depending on the screen size and resolution.

Although, in the embodiment, LCD 6 of electronic camera 1 is used as a display screen, the invention is similarly applicable to other types of display devices to divide the screen into multiple areas to display a plurality of images.

In the described embodiments the information items that could be selected included one or more types of information (e.g., thumbnail image, memo and/or sound). The invention also is applicable to embodiments in which the information items that can be selected correspond to one or more of the individual entries that are associated with a particular time. Thus, rather than selecting the numbers 1-4 shown on the left side of the FIG. 9 display, the user can select only the thumbnail from entry number 1 or only the sound from entry number 2, for example. In such an example, the divided display would only display the reduced image from entry number 1 (no sound icon) and only the sound icon from entry number 2 (no reduced image).

Although the JPEG and run length encoding compression techniques were described, other compression techniques (or no compression at all) can be used with the invention.

Although a touch tablet with input pen were described as structures through which selections and commands can be input, the invention is not limited to such structure. For example, the touch tablet can be actuable by the user's finger. Additionally, selections and commands can be input without using a touch tablet. For example, a cursor can be moved (e.g., via a mouse) and selections or commands can be made by clicking.

The invention is not limited to implementation by a programmed general purpose computer as shown in the preferred embodiment. For example, the invention can be implemented using one or more special purpose integrated circuit(s) (e.g., ASIC). It will be appreciated by those skilled in the art that the invention can also be implemented using one or more dedicated or programmable integrated or other electronic circuits or devices (e.g., hardwired electronic or logic circuits such as discrete element circuits, or programmable logic devices such as PLDs, PLAs, PALs or the like). In general, any device or assembly of devices on which a finite state machine capable of implementing the flow charts shown in FIG. 18 can be used.

In an information processing apparatus according to one aspect of the invention, a display controller displays one or more images designated by a designation device on predetermined areas of the screen. The display controller divides the screen into a plurality of display areas according to the number of images designated. The display controller displays each of the designated images in a corresponding one of the divided areas, thereby displaying multiple images on a screen in an efficient way.

In an information processing apparatus according to another aspect of the invention, a designation device designates one or more images input through an image input device (and/or stored in a memory). The display controller controls the image size displayed on a screen according to the number of the images designated by the designation device, thereby displaying multiple images on a screen in an efficient way.

According to another aspect of the invention, a recording medium stores a computer-readable control program that is used by a controller of an information processing apparatus to receive a designation of one or more images to be displayed and to divide a screen into a plurality of areas corresponding to the number of the designated images. The control program also includes instructions to display the one or more designated images on the areas of the divided screen. Thus, a screen can be divided into a specified number of areas corresponding to the number of designated images, and a plurality of the images can be effectively displayed on one screen.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. An information processing apparatus comprising:
a memory that stores a plurality of images and other information data, each of the plurality of images and other information data stored relative to each other according to a predetermined storing order; and
a controller, coupled to the memory, and that divides a display screen into n² areas and that displays each of one or more of the images as reduced images that are smaller than 1/n height by 1/n width of the display screen in a corresponding one of the n² areas of the screen, and that displays a symbol representative of the other information data in a corresponding one of the n² areas of the screen;
wherein the reduced images and said symbol are displayed in n² areas of the screen according to the predetermined storing order.

2. The apparatus of claim 1, wherein the other information data is sound data.

3. The apparatus of claim 1, wherein the number of the displayed images is greater than (n−1)² and equal to or less than n².

4. The apparatus of claim 3, wherein n is a natural number.

5. The apparatus of claim 1, further comprising a selector that selects one of the images displayed in the n² areas, and wherein the controller displays the selected image so as to occupy an entire area of the screen.

6. The apparatus of claim 2, wherein when images that are displayed include sound data associated therewith, the controller displays the images in the corresponding display areas of the screen together with the symbol indicating the existence of the sound data associated with the images.

7. The apparatus of claim 2, wherein when sound data does not include an image associated therewith, the controller displays the symbol representative of the sound data in the corresponding display area.

8. The apparatus of claim 2, further comprising:
a speaker that plays back the sound data; and
a selector that selects one of the images displayed in the n² areas;
wherein when the image selected by the selector has sound data associated therewith, the controller displays the selected image so as to occupy the entire area of the screen, and the speaker plays back the sound data associated therewith.

9. The apparatus of claim 1, further comprising a touch tablet coupled to the controller to input line drawings, wherein when the displayed images have corresponding line-drawings input through the touch tablet, the controller displays the images and the corresponding line-drawings in the screen with the line-drawings superimposed on the corresponding images.

10. The apparatus of claim 1, further comprising a display coupled to the controller and having the display screen to display the images.

11. The apparatus of claim 1, wherein the apparatus is an electronic camera that further comprises a photoelectric converter that converts a light image of an object to image signals that are stored in the memory.

12. An information processing apparatus comprising:
a memory that stores a plurality of images and other information data, each of the plurality of images and other information data stored relative to each other according to a predetermined storing order, the total number of the images and the other information data is p; and
a controller, coupled to the memory, and that divides a display screen into n² areas, and that displays the images and the other information data such that: (i) when n²<p, n² of the p images and other information data are displayed; and (ii) when n²>p, the p images and other information data are displayed starting from an upper-most, left-most one of the n² areas, and (n²−p) blank images are displayed after the p images and other information data;
wherein the images and other information data are displayed in n² areas of the screen according to the predetermined storing order.

13. The apparatus of claim 12, wherein the apparatus is an electronic camera that further comprises a photoelectric converter that converts a light image of an object to image signals that are stored in the memory.

14. A method of controlling an information processing apparatus that controls the display of information relating to a plurality of images and other information data stored in a memory in a predetermined storing order, comprising the steps of:
dividing a display screen into n² areas; and
displaying each of one or more of the images as reduced images that are smaller than 1/n height by 1/n width of the display screen in a corresponding one of the areas of the divided screen, and displaying a symbol representative of the other information data in a corresponding one of the areas of the divided screen;
wherein the reduced images and the symbol are displayed in n² areas of the screen according to the predetermined storing order.

15. The method of claim 14, wherein the other information data is sound data.

16. The method of claim 14, wherein the dividing step divides the screen so that an aspect ratio of the n² areas is equal to an aspect ratio of the displayed images.

17. The method of claim 14, wherein the number of the displayed images is greater than (n−1)² and equal to or less than n².

18. The method of claim 17, wherein n is a natural number.

19. The method of claim 14, further comprising the steps of:
selecting one of the images displayed in the n² areas; and
displaying the selected image so as to occupy an entire area of the screen.

20. The method of claim 15, further comprising the steps of:
selecting one of the images displayed in the n² areas; and
when the selected image has sound data associated therewith, the displaying step displays the selected image so as to occupy the entire area of the screen, and the sound data associated therewith is reproduced.

21. A method of controlling an information processing apparatus, comprising the steps of:
retrieving one or more of a plurality of images and other information data stored in a memory in a predetermined storing order, the total number of the retrieved images and other information data is p;
dividing a display screen into n² areas; and
displaying the images and the other information data such that: (i) when n²<p, n² of the p images and other information data are displayed; and (ii) when n²>p, the p images and other information data are displayed starting from an upper-most, left-most one of the n² areas, and (n²−p) blank images are displayed after the p images and other information data;
wherein the reduced images and other information data are displayed in n² areas of the screen according to the predetermined storing order.

22. A recording medium that stores a computer-readable control program having instructions that are executable by an information processing apparatus, that controls the display of information relating to a plurality of images and other information data stored in a memory, each of the plurality of images and other information data stored relative to each other according to a predetermined storing order, to perform the steps of:
dividing a display screen into n² areas; and
displaying each of one or more of the images as reduced images that are smaller than 1/n height by 1/n width of the display screen in a corresponding one of the divided areas of the display screen, and displaying a symbol representative of the other information data in a corresponding one of the divided areas of the display screen;
wherein the reduced images and the symbol are displayed in n² areas of the screen according to the predetermined storing order.

23. The recording medium of claim 22, wherein the other information data is sound data.

24. The recording medium of claim 22, wherein the dividing step divides the screen so that an aspect ratio of the n² areas is equal to an aspect ratio of the displayed images.

25. The recording medium of claim 22, wherein the number of the displayed images is greater than (n−1) and equal to or less than n².

26. The recording medium of claim 22, wherein the control program further comprises instructions to perform the steps of:
allowing for the selection of one of the images displayed in the n² areas; and
displaying the selected image so as to occupy an entire area of the screen.

27. The recording medium of claim 23, wherein the control program further includes instructions to perform the steps of:
allowing for the selection of one of the images displayed in the n² areas; and
when the selected image has sound data associated therewith, the displaying step displays the selected image so as to occupy the entire area of the screen, and the sound data associated therewith is reproduced.

28. A recording medium that stores a computer-readable control program having instructions that are executable by an information processing apparatus, that controls the display of information relating to a plurality of images and other information data stored in a memory, to perform the steps of:
retrieving one or more of the images and the other information data stored in a predetermined storing order, the total number of the retrieved images and other information data is p;
dividing a display screen into n² areas; and
displaying the images and the other information data such that: (i) when n²<p, n² of the p images and other information data are displayed; and (ii) when n²>p, the p images and other information data are displayed starting from an upper-most, left-most one of the n² areas, and (n²−p) blank images are displayed after the p images and other information data;
wherein the images and other information data are displayed in n areas of the screen according to the predetermined storing order.
